(19) United States
(12) Patent Application Publication
(10) Pub. No.: US 2025/0390869 A1
(43) Pub. Date: Dec. 25, 2025

(54) MACHINE LEARNING BASED POST-AUTHORIZATION MODELING SYSTEM AND METHOD

(71) Applicant: MASTERCARD INTERNATIONAL INCORPORATED, Purchase, NY (US)

(72) Inventors: Ushmita Pareek, Khargone (IN); Arun Kanthali, Dewas (IN); Christopher John Merz, Wildwood, MO (US); Harsimran Bhasin, New Delhi (IN); Joshua A. Allbright, Chesterfield, MO (US); Maneet Singh, New Delhi (IN); Sudhir Jha, Fremont, CA (US)

(21) Appl. No.: 18/750,826

(22) Filed: Jun. 21, 2024

(51) Int. Cl. G06Q 20/40

(52) U.S. Cl. CPC G06Q 20/401

(57) ABSTRACT

A computing system for applying post-authorization modeling tools to a payment transaction for enhancing a decision intelligence (DI) score is disclosed. The computing system is configured to: (i) build a pre-authorization and a post-authorization model to analyze backward velocities and forward velocities; (ii) receive an authorization message for a current transaction; (iv) input into the pre-authorization model current transaction data and the backward velocities for the current transaction to output a DI score; (v) based upon the DI score, authorize the current transaction; (vi) continuously monitor a data feed for a predefined period of time after authorizing the current transaction; (viii) update a data register to include the forward velocities for any post-authorization transactions received during the predefined period of time; (ix) update the DI score for the current transaction by inputting the forward velocities into the post-authorization model to transmit the updated DI score to the merchant.

This disclosure relates generally to machine learning based post-authorization modeling in a computer network and, more particularly, to an enhanced fraud detection system that uses machine-learning based post-authorization models to re-score a transaction after the transaction has been initially scored and authorized to refine the score as a better indicator of whether the transaction is fraudulent.

Payment processing networks process numerous payment card transactions every day that are initiated by cardholders of payment cards. Most of these payment card transactions are valid transactions. However, at least some of these payment card transactions are fraudulent. Payment card transaction processors, such as payment networks and issuing banks, may monitor payment card transactions for signs of fraudulent activity. At least some known fraud detection systems monitor payment card transactions one payment card transaction at a time to determine whether the payment card transaction is potentially fraudulent. These known fraud detection systems evaluate certain data points associated with the transaction such as, for example, the transaction amount, the time and date of the transaction, the merchant involved in the transaction, and the payment card identifier initiating the transaction, and then score the transaction. The score is an indicator of whether that transaction is predicted to be fraudulent or legitimate. In other words, these known fraud detection systems examine the particular transaction and try to predict based on certain data points associated with that transaction whether the authorized cardholder is making the purchase or whether a fraudster is trying to make the purchase. If the transaction is scored as being legitimate, the transaction may then be authorized for payment.

In some cases, these known fraud detection systems may consider past transactions when evaluating a current transaction for fraud detection. However, these known fraud detection systems do not consider subsequent or near-term future transactions when evaluating a current transaction for fraud. Future transactions using the same payment card account may help in determining whether a current transaction is fraudulent. Unfortunately, these known fraud detection systems are unable to take into account future transactions when scoring a current transaction for fraud.

Accordingly, it is desirable to have a system and/or method that is able to evaluate both past and future transactions involving a payment account when processing a current payment transaction. And in those cases where a transaction is initially authorized for payment but later found to be fraudulent through subsequent transactions, the transaction is able to be declined post-authorization and the fraud is prevented.

### BRIEF DESCRIPTION

In one embodiment, a computing system for applying post-authorization modeling tools to a payment transaction for enhancing a decision intelligence (DI) score is disclosed. The computing system includes at least one processor, and at least one memory in communication with the at least one processor. The at least one processor is programmed to: (i) build, using a velocity engine, a pre-authorization model using historical transaction data for a candidate user, the pre-authorization model configured to analyze backward velocities; (ii) build, using the velocity engine, a post-authorization model using historical transaction data for the candidate user, the post-authorization model configured to analyze forward velocities; (iii) receive an authorization message for a current transaction including current transaction data including at least an account identifier identifying an account used to initiate the current transaction, and a merchant identifier identifying a merchant with whom the current transaction was initiated with; (iv) input into the pre-authorization model the current transaction data and the backward velocities for the current transaction to output a DI score, wherein the current transaction includes a transaction identifier; (v) based upon the DI score, authorize the current transaction; (vi) store, in a data register within the at least one memory, the transaction identifier along with the DI score and the backward velocities for the current transaction; (vii) continuously monitor a data feed for a predefined period of time after authorizing the current transaction to detect any post-authorization transactions initiated using the same account identifier; (viii) update the data register within the at least one memory for the transaction identifier to include the forward velocities for any post-authorization transactions received during the predefined period of time; (ix) in response to the predefined period of time expiring, update the DI score for the current transaction by inputting the forward velocities into the post-authorization model; and (x) transmit the updated DI score to the merchant with whom the current transaction was initiated with.

In another embodiment, a computer-implemented method for applying post-authorization modeling tools to a payment transaction for enhancing a decision intelligence (DI) score is disclosed. The method is implemented by a computing system including at least one processor. The method includes (i) building a pre-authorization model using historical transaction data for a candidate user, the pre-authorization model configured to analyze backward velocities; (ii) building a post-authorization model using historical transaction data for the candidate user, the post-authorization model configured to analyze forward velocities; (iii) receiving an authorization message for a current transaction including current transaction data including at least an account identifier identifying an account used to initiate the current transaction, and a merchant identifier identifying a merchant with whom the current transaction was initiated with; (iv) inputting into the pre-authorization model the current transaction data and the backward velocities for the current transaction to output a DI score, wherein the current transaction includes a transaction identifier; (v) based upon the DI score, authorizing the current transaction; (vi) storing, in a data register within at least one memory, the transaction identifier along with the DI score and the backward velocities for the current transaction; (vii) continuously monitoring a data feed for a predefined period of time after authorizing the current transaction to detect any post-authorization transactions initiated using the same account identifier; (viii) updating the data register within the at least one memory for the transaction identifier to include the forward velocities for any post-authorization transactions received during the predefined period of time; (ix) in response to the predefined period of time expiring, updating the DI score for the current transaction by inputting the forward velocities into the post-authorization model; and (x) transmitting the updated DI score to the merchant with whom the current transaction was initiated with.

In a further embodiment, at least one non-transitory computer-readable storage media having computer-executable instructions embodied thereon for applying post-authorization modeling tools to a payment transaction for enhancing a decision intelligence (DI) score is disclosed. The computer-executable instructions, when executed by at least one processor, cause the at least one processor to: (i) build, using a velocity engine, a pre-authorization model using historical transaction data for a candidate user, the pre-authorization model configured to analyze backward velocities; (ii) build, using the velocity engine, a post-authorization model using historical transaction data for the candidate user, the post-authorization model configured to analyze forward velocities; (iii) receive an authorization message for a current transaction including current transaction data including at least an account identifier identifying an account used to initiate the current transaction, and a merchant identifier identifying a merchant with whom the current transaction was initiated with; (iv) input into the pre-authorization model the current transaction data and the backward velocities for the current transaction to output a DI score, wherein the current transaction includes a transaction identifier; (v) based upon the DI score, authorize the current transaction; (vi) store, in a data register within at least one memory, the transaction identifier along with the DI score and the backward velocities for the current transaction; (vii) continuously monitor a data feed for a predefined period of time after authorizing the current transaction to detect any post-authorization transactions initiated using the same account identifier; (viii) update the data register within the at least one memory for the transaction identifier to include the forward velocities for any post-authorization transactions received during the predefined period of time; (ix) in response to the predefined period of time expiring, update the DI score for the current transaction by inputting the forward velocities into the post-authorization model; and (x) transmit the updated DI score to the merchant with whom the current transaction was initiated with.

### BRIEF DESCRIPTION OF THE DRAWINGS

FIGS. 1-6 show example embodiments of the methods and systems described herein.

FIG. 1 is a schematic diagram illustrating an example multi-party payment card industry system for enabling payment-by-card transactions between merchants, acquirers, card issuers, and/or payment processors having a post-authorization fraud analysis system in accordance with the present disclosure.

FIG. 2 is a simplified block diagram of the post-authorization fraud analysis computing system shown in FIG. 1 in communication with the payment interchange network shown in FIG. 1 in accordance with one embodiment of the present disclosure.

FIG. 3 illustrates an example configuration of a client system shown in FIG. 2.

FIG. 4 illustrates an example configuration of a server system shown in FIG. 2.

FIG. 5A shows an example data engineering pipeline of the post-authorization fraud analysis computing system shown in FIG. 1.

FIG. 5B shows an example data modeling pipeline of the post-authorization fraud analysis computing system shown in FIG. 1.

FIG. 5C shows an example data deployment pipeline of the post-authorization fraud analysis computing system shown in FIG. 1.

FIG. 6 is a flow diagram of a computer-implemented method for applying post-authorization modeling tools to a payment transaction for enhancing a decision intelligence (DI) score.

### DETAILED DESCRIPTION

Embodiments of the present disclosure describe a post-authorization modeling computing system and method implemented using the post-authorization modeling computing system. The post-authorization modeling computer system is in communication with a data warehouse associated with a payment processing network. Machine learning tools are used in combination with the post-authorization modeling computing system. The post-authorization modeling (PAM) system is configured to provide enhanced fraud detection to a payment processing system by using machine-learning tools to re-score (e.g., decision intelligence score or fraud indicator score) a transaction after the transaction has been initially scored and authorized to refine the score as a better indicator of whether the transaction is fraudulent. In other words, transactions performed after a current transaction is scored and authorized are analyzed. Those subsequent transactions are analyzed and applied backwards to the current transaction to determine how those transactions might impact the decision intelligence score of that current transaction.

As describe herein, merchants in, for example, the e-commerce space, have a time lag between the time of the transaction being initiated and the time of fulfillment. The system and method described herein utilizes this time lag window to provide an enhanced post-authorization score to help reduce losses due to fraud at these merchants. The post-authorization models may also be used for updating decision intelligence (DI) scores used further in downstream applications and proactive model monitoring. As used herein, DI refers to a real-time authorization decisioning solution that applies thousands of data points and sophisticated modeling techniques to each transaction, simplifying these insights into a single transaction decision score that helps issuers fine-tune their authorization decisions in order to approve more genuine transactions without increasing risk. The post-authorization models described herein incorporate insights from transactions occurring in a short time interval after a transaction in question to reconcile fraud risk associated with it. As described below, the PAM system uses forward velocities to incorporate transaction activity taking place using the same card account identifier up to 30 minutes (or some other predesignated time period or at time intervals) after a transaction. The resulting improvements in fraud detection versus false positives are clearly achieved when applying the PAM system and using the post-authorization modeling techniques. As described herein, velocities refer to transaction velocities including rates of various metrics at which transactions are processed by the network.

In the example embodiment, the PAM system receives an authorization request message that includes data associated with a payment transaction. In some cases, the PAM system may also receive authentication data associated with the payment transaction and the user computing device used to initiate the transaction. The PAM system analyzes the received data and scores the current transaction indicating whether the transaction is likely to be a legitimate transaction or a fraudulent transaction. In some cases, the data analyzed includes data associated with the current transaction and data associated with prior transactions leading up to the current transaction. In some cases, the data includes velocities for the current and prior transactions.

After evaluating the numerous data parameters associated with the transaction, the PAM system embeds the DI score in the authorization request message and transmits it to the issuer of the payment account that initiated the transaction. The issuer, or someone on behalf of the issuer, authorizes or denies the transaction based upon the score provided and/or other information. If the issuer authorizes the transaction, the issuer returns an authorization response message with the approval to complete the transaction. The PAM system then stores the current transaction data and the initial DI score in a manager queue for a pre-designated period of time so that any near-term (during the pre-designated period time) post transactions that occur can be evaluated (forward velocities) and applied back to the current transaction stored in the manager queue. By so doing, the PAM system is able to re-score the current transaction after it has been initially authorized to determine whether any of the near-term, subsequent transactions impact the DI score of the current transaction.

The PAM system is configured to use as inputs different kinds of velocities in the post-authorization modeling including (i) regular historical (or backward) velocities, and (ii) forward (or post-authorization) velocities. Accordingly, in one example, for a transaction happening at time t (e.g., 11:30 AM), the PAM system may score the transaction happening at time t and then re-score the same transaction at time 1+x (e.g., 11:45 AM). Backward velocities may be created at time 11:30 AM using a snapshot of prior transactions occurring, for example, in the past 56 days (referenced herein as a lookback period), and forward velocities may be created using a look forward period of, for example, 15 minutes, or for transactions occurring between 11:30 AM and 11:45 AM. Although 56 days is described as an example amount of time for a lookback, it should be understood that other time periods or ranges (e.g., 30 to 60 days, or some other similar range) of time could be used in this system.

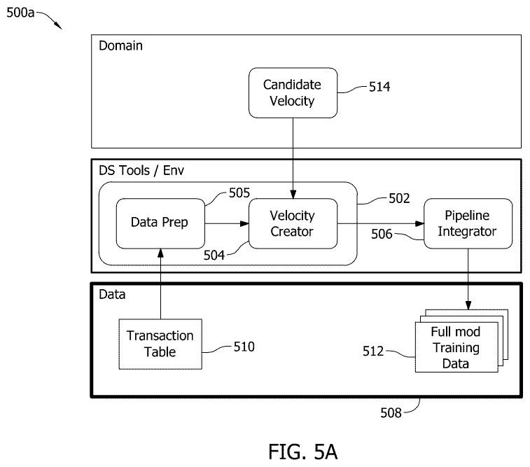

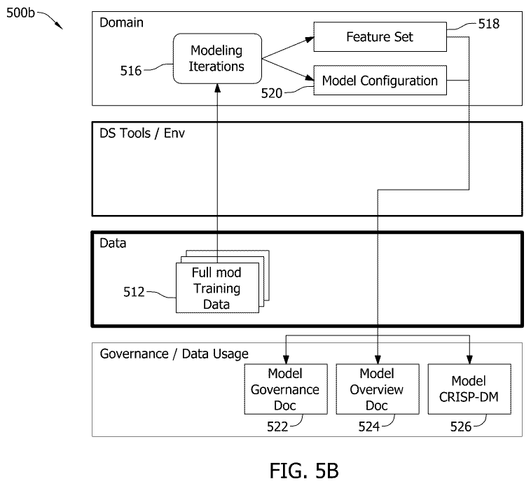

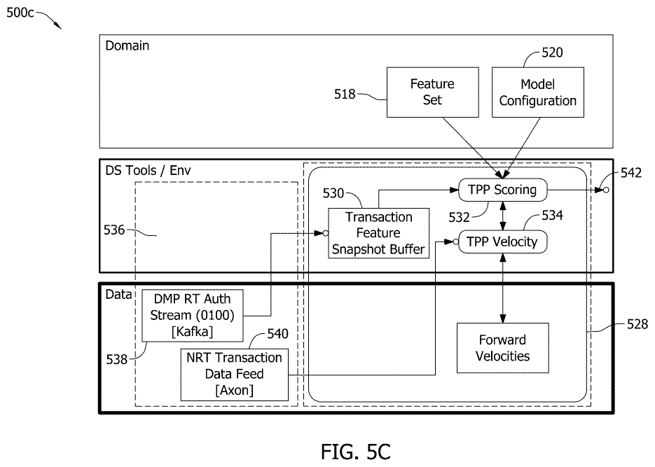

In some embodiments, and by way of a non-limiting example, a data engineering pipeline of the PAM system may include components like a pipeline generator (shown in FIG. 5A as 502), a velocity creator (shown in FIG. 5A as 504), a pipeline integrator 506, and/or datastores. The pipeline generator 502 may be implemented as an interactive job which may perform various steps or operations repeatedly (periodically or aperiodically) to advance through a modeling data window and generate velocities (e.g., regular historical velocities and/or forward velocities) for a training window. The training window may include the lookback period for the regular historical velocities and the look forward period for the forward velocities.

The velocity creator 504 may be a subcomponent of the pipeline generator 502, and the velocity creator 504 may generate the regular historical velocities and the forward velocities based upon data associated with transactions in the lookback period and the look forward period. The velocity creator 504 may generate the regular historical velocities and the forward velocities in accordance with candidate velocity configurations. The candidate velocity configurations provide description of all features and how to compute various features. The pipeline integrator 506 may be implemented as a process or a task that merges the regular historical velocities, forward velocities, and various transaction elements for transactions in the lookback period and the look forward period.

The datastores may include a transaction table datastore and full mod training data datastore. The transaction table datastore may include transactions and their related elements to create the regular historical velocities and forward velocities. The velocity creator 504 component may fetch data from the transaction table datastore to create or generate the regular historical velocities and forward velocities. The full mod training data datastore may include an n-month transaction dataset consisting of raw data fields and the derived regular historical velocities and forward velocities outputted by the pipeline integrator 506. Accordingly, the n-month transaction dataset may include transactions for n number of months of which transactions are used for training and validation.

In other words, the pipeline generator 502 entails a set of processes that runs over the dataset fetched from an existing transaction table and creates an intermediate dataset referred as “scoring window,” which enables the velocity creator 504 module to generate forward and backward velocities on the set of selected transactions. The dataset fetched from the existing transaction table may be prepared for creating the intermediate dataset by extracting or fetching transaction level data elements from the transactional data. By way of a non-limiting example, the transaction level data elements may include, but are not limited to, a merchant identification number, a card number, a declined transaction indicator, a fraudulent transaction indicator, a decision intelligence (DI) score, and/or fraud labels. The transaction data elements may be extracted from transactions that occurred over the lookback period (e.g., the last 56 days, or any other number of days) prior to creating or generating the training snapshot for generating the regular historical velocities, and up to the look forward period (e.g., 15 minutes after the last transaction of the snapshot) for creating or generating the forward velocities. Additionally, declined transactions having a positive decline labeling logic (DLL) label may also be used for training the model.

In some embodiments, different anchors (e.g., data parameters analyzed for calculating the different velocities) including an identifier key, a transaction type, an amount or count velocity, a response code, a forward peek time period, and/or derived velocities may be considered for generating forward velocities. The identifier key may include a card number (card_num), a merchant identifier (merch), and/or a merchant category code (MCC). The transaction type denotes transaction characteristics that may be used for feature creation or to generate forward velocities. By way of a non-limiting example, a transaction type referenced herein as “aiss” corresponds with transactions associated with a restricted card, and/or attempted transactions beyond set limits or available funds, and may be used for feature creation or to generate forward velocities. Additionally, or alternatively, the transaction types used for feature creation or generating forward velocities may include, but are not limited to, the following (i) “aoth” corresponding to a denied transaction by an issuer, or transactions identified as do not honor; (ii) “auth” corresponding to credit transactions; (iii) “debit” corresponding to debit transactions; (iv) “cp” corresponding to card present transactions; (v) “cnp” corresponding to card-not-present transactions; (vi) “decline” corresponding to declined transactions; (vii) “money_send_mcc” corresponding to transactions associated with MoneySend® (a money transfer service), money transfer or payment on invoice (POI) funding MCCs; (viii) “xbr” corresponding to cross-border transactions; (ix) “xbr_cnp” corresponding card-not-present cross-border transactions; (x) “txn” corresponding to all transactions; (xi) “cvv_ver” corresponding to transactions where verification of a card verification value (CVV) is performed successfully; and/or (xii) “cvv_unver” corresponding to transactions where verification of a CVV has failed. The amount or count velocity may include a sum of transaction (sum) authorized amount and/or a number of transactions (count). The response code may include a response code of the card's last transaction and/or the response code of the current transaction. The forward peek time period may be 1 minute (fwd1m), 5 minutes (fwd5m), 10 minutes (fwd10m), and/or 15 minutes (fwd15m). The derived velocities may be represented as a ratio (rat), a difference (ps), and/or a distribution (dist). Accordingly, forward velocities may be generated based upon one or more combinations of anchors, for example, card_num_cnp_count_fwd10m_fwd15m_rat, card_num_xbr_cnp_sum_fwd1m_fwd5m_ps, and/or card_num_decl_count_cur_fwd1m_dist.

Similarly, as described herein, the velocity creator generates the forward velocities and the backward velocities for each transaction in the scoring window including the lookback period and the look forward period. In some embodiments, the velocity creator may import or fetch backward velocities stored in the data management platform as a near real-time feed instead of generating the backward velocities.

In some embodiments, a data modeling pipeline of the PAM system may include a process or task that is referenced herein as modeling iterations leveraging data science workbench tools and the conventional cross-industry standard process for data mining (CRISP-DM shown in FIG. 5B) using the n-month transaction dataset stored in the full mod training data datastore. The modeling iterations process may generate a feature set providing a configuration-based description of all features and how to compute the features. Additionally, the modeling iterations process may also generate model configuration files for deploying in a transactions processing platform (TPP). The data modeling pipeline may use the datasets generated by the pipeline integrator for model training, validation, and/or testing by (i) identifying optimal model hyper-params (e.g., a number of trees, a learning rate, or depth, etc.); (ii) finalizing a minimal set of features base; and (iii) validating the model performance over a blind dataset to capture model performance metrics. The modeling iterations thus deliver a final feature list and model configuration files for use by a scoring manager, which is shown in FIG. 5C as a TPP scoring component of a deployment pipeline described below.

In some embodiments, a deployment pipeline of the PAM system may include functional blocks performing computations in real-time and near real-time settings for deploying a tree-based trained classifier. The deployment pipeline may include a scoring manager including a transaction feature snapshot buffer, a TPP scoring component, and a TPP velocity engine. The TPP scoring component takes the feature set and model configuration files generated by the data modeling pipeline as inputs to the transactions scoring model. The TPP scoring components may also trigger the TPP velocity engine that generates a transaction feature snapshot that corresponds with the regular historical velocities and forward velocities for a particular transaction. In some embodiments, and by way of a non-limiting example, the TPP velocity engine may port traditional transaction features or the regular historical velocities from a data management platform as a real-time authorization transaction data feed. The real time authorization transaction data feed may include a filtered set of the regular historical velocities required for the model with a small delay from the actual time of transaction. The transaction feature snapshot buffer may store the regular historical velocities for the particular transaction for later scoring (re-scoring) with the forward velocities for the maximum period of 30 minutes, for example. Additionally, or alternatively, the TPP velocity engine may also use one or more transaction feeds including data elements for computing velocity in near-real time (e.g., with a delay of a couple of seconds from the actual time of transaction). The TPP scoring component may provide the score value generated based upon the regular historical velocities and forward velocities to a merchant, an acquirer, or a user computing device for displaying in a graphical user interface. By way of a non-limiting example, the score value may be provided using a push application programming interface or a pull application programming interface.

The technical problems addressed by this system include at least one of: (i) undetected network-based fraud events on a payment card transaction network, especially those targeted at accounts issued by a specific issuer; (ii) increased network load based on some types of fraud events; (iii) computational burdens imposed by automated fraud monitoring systems; and (iv) too little contrast between fraudulent transactions and legitimate transactions in some time frames to make detection possible. Other technical problems addressed by the system and methods described herein may include increased network usage (slowing down the network) due to undetected frauds (e.g., systematic attacks to determine card verification numbers through trial and error).

The methods and systems described herein may be implemented using computer programming or engineering techniques including computer software, firmware, hardware, or any combination or subset thereof, wherein the technical effects may be achieved by performing at least one of the following steps: (i) building a pre-authorization model using historical transaction data for a candidate user, the pre-authorization model configured to analyze backward velocities; (ii) building a post-authorization model using historical transaction data for the candidate user, the post-authorization model configured to analyze forward velocities; (iii) receiving an authorization message for a current transaction including current transaction data including at least an account identifier identifying an account used to initiate the current transaction, and a merchant identifier identifying a merchant with whom the current transaction was initiated with; (iv) inputting into the pre-authorization model the current transaction data and the backward velocities for the current transaction to output a DI score, wherein the current transaction includes a transaction identifier; (v) based upon the DI score, authorizing the current transaction; (vi) storing, in a data register within at least one memory, the transaction identifier along with the DI score and the backward velocities for the current transaction; (vii) continuously monitoring a data feed for a predefined period of time after authorizing the current transaction to detect any post-authorization transactions initiated using the same account identifier; (viii) updating the data register within the at least one memory for the transaction identifier to include the forward velocities for any post-authorization transactions received during the predefined period of time; (ix) in response to the predefined period of time period expiring, updating the DI score for the current transaction by inputting the forward velocities into the post-authorization model; and (x) transmitting the updated DI score to the merchant with whom the current transaction was initiated with.

The resulting technical effect achieved by this system is at least one of: (i) reducing network-based fraud events through early detection; (ii) reducing network-based fraud events through multiple fraud detection methods; (iii) applying both transactions prior to the current transaction and transactions occurring in a near future of the current transaction for identifying fraudulent nature of the transaction and alerting the acquirer or merchant; and (iv) early detection and reaction (e.g., mitigation steps deployed) to attacks on a computer network, and thereby eliminating economic loss through these fraud attacks. Thus, the system enables enhanced fraud detection on the payment card transaction network. In addition, by reducing network-based fraud events, this system also improves on the overall performance of the network by reducing the number of messages that need to be processed over the network. So by implementing this system, unnecessary messages are removed from the system by early detection, and thus, there is an improvement in reducing the amount of computational resources needed to process these messages, improving the overall efficiency of the system and reducing the amount of memory for storing the messages.

As used herein, the term “database” may refer to either a body of data, a relational database management system (RDBMS), or to both. As used herein, a database may include any collection of data including hierarchical databases, relational databases, flat file databases, object-relational databases, object oriented databases, and any other structured collection of records or data that is stored in a computer system. The above examples are example only, and thus are not intended to limit in any way the definition and/or meaning of the term database. Examples of RDBMS's include, but are not limited to including, Oracle® Database, MySQL, IBM® DB2, Microsoft® SQL Server, Sybase®, and PostgreSQL. However, any database may be used that enables the systems and methods described herein. (Oracle is a registered trademark of Oracle Corporation, Redwood Shores, California; IBM is a registered trademark of International Business Machines Corporation, Armonk, New York; Microsoft is a registered trademark of Microsoft Corporation, Redmond, Washington; and Sybase is a registered trademark of Sybase, Dublin, California.)

As used herein, a “processor” may include any programmable system including systems using central processing units, microprocessors, micro-controllers, reduced instruction set circuits (RISC), application specific integrated circuits (ASICs), logic circuits, and any other circuit or processor capable of executing the functions described herein. The above examples are example only and are thus not intended to limit in any way the definition and/or meaning of the term “processor.”

As used herein, the terms “software” and “firmware” are interchangeable and include any computer program stored in memory for execution by a processor, including RAM memory, ROM memory, EPROM memory, EEPROM memory, and non-volatile RAM (NVRAM) memory. The above memory types are example only and are thus not limiting as to the types of memory usable for storage of a computer program.

In one embodiment, a computer program is provided, and the program is embodied on a computer readable medium. In an example embodiment, the system is executed on a single computer system, without requiring a connection to a sever computer. In a further embodiment, the system is being run in a Windows® environment (Windows is a registered trademark of Microsoft Corporation, Redmond, Washington). In yet another embodiment, the system is run on a mainframe environment and a UNIX® server environment (UNIX is a registered trademark of X/Open Company Limited located in Reading, Berkshire, United Kingdom). The application is flexible and designed to run in various different environments without compromising any major functionality. In some embodiments, the system includes multiple components distributed among a plurality of computing devices. One or more components may be in the form of computer-executable instructions embodied in a computer-readable medium.

The systems and processes are not limited to the specific embodiments described herein. In addition, components of each system and each process can be practiced independent and separate from other components and processes described herein. Each component and process can also be used in combination with other assembly packages and processes.

As used herein, the terms “transaction card,” “financial transaction card,” and “payment card” refer to any suitable payment card, such as a credit card, a debit card, a prepaid card, a charge card, a membership card, a promotional card, a frequent flyer card, an identification card, a prepaid card, a gift card, and/or any other payment device that may hold payment account information, such as mobile phones, Smartphones, personal digital assistants (PDAs), key fobs, and/or computers. Each type of payment device can be used as a method of payment for performing a transaction.

As used herein, the term “fraud” is used in the context of payment card transactions and refers, generally, to an unprivileged use of a payment card. For example, a thief may steal a consumer's payment card or information from that payment card (e.g., a payment account number [PAN], expiration date, security code) and attempt to use the payment card for purchases. This type of transaction may be monitored by, for example, a fraud detection system within a payment network. Further, as used herein, a “suspected fraudulent transaction” is a payment card transaction that is suspected to be fraudulent, but which has not yet been confirmed as fraudulent by, for example, the consumer of the underlying payment card, or the issuing bank, or an analyst associated with the fraud detection system.

As used herein, the term “real-time” is used, in some contexts, to refer to a regular updating of data within a system such as the fraud detection systems, the fraud management systems, and/or the displays described herein. When a system is described as processing or performing a particular operation “in real-time,” this may mean within seconds or minutes of an occurrence of some trigger event, such as new data being generated, or on some regular schedule, such as every minute. In other contexts, some payment card transactions require “real-time” fraud operations, such as fraud scoring, which refers to operations performed during authorization of a payment card transaction (i.e., between the moment that a new payment card transaction is initiated from, for example, a merchant, and the time that an authorization decision is made, for example, back to that merchant). In such a context, “near real-time” fraud operations are operations conducted shortly after the payment card transaction has occurred (i.e., after an authorization decision is made).

As used herein, the term “transaction velocity” is used to generally relate to a number of qualifying transactions initiated by one or more consumers using one or more payment devices, where the transactions qualify if they meet one or more qualifying criteria (e.g., happening within a certain period of time, having a fraud score within a certain fraud score range).

The following detailed description illustrates embodiments of the disclosure by way of example and not by way of limitation. It is contemplated that the disclosure has general application to fraud management of payment card transactions.

As used herein, an element or step recited in the singular and proceeded with the word “a” or “an” should be understood as not excluding plural elements or steps, unless such exclusion is explicitly recited. Furthermore, references to “example embodiment” or “one embodiment” of the present disclosure are not intended to be interpreted as excluding the existence of additional embodiments that also incorporate the recited features.

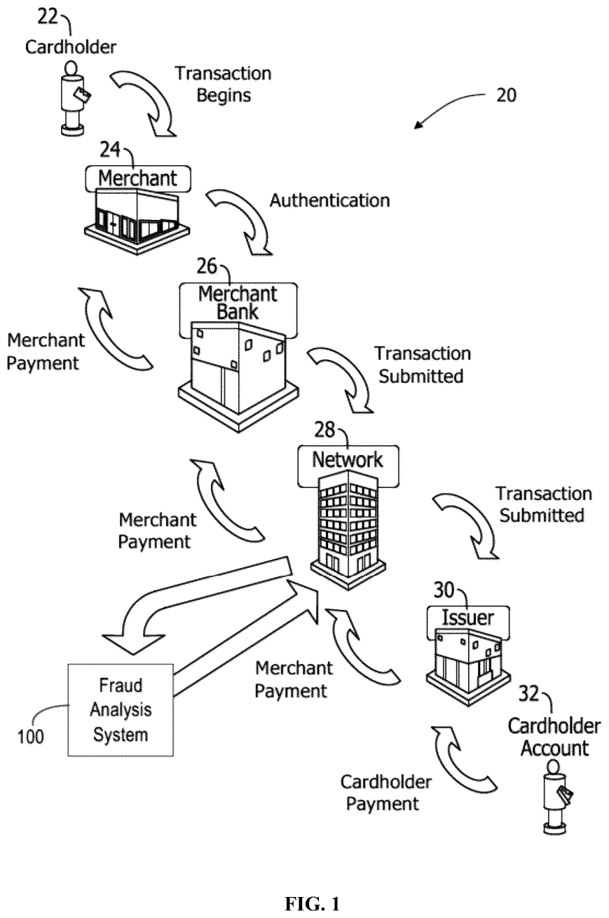

FIG. 1 is a schematic diagram illustrating an example multi-party payment card industry system 20 for enabling payment-by-card transactions between merchants 24 and issuer banks 30 having a post-authorization fraud analysis system 100 as described further below. Embodiments described herein may relate to a payment card system, such as a credit card payment system using the Mastercard® interchange network. The Mastercard® interchange network is a set of proprietary communications standards promulgated by Mastercard International Incorporated® for the exchange of financial transaction data and the settlement of funds between financial institutions that are members of Mastercard International Incorporated®. (Mastercard is a registered trademark of Mastercard International Incorporated located in Purchase, New York).

In a typical payment card system, a financial institution called the “issuer” 30 issues a payment card, such as a credit card, to a consumer or cardholder 22, who uses the payment card to tender payment for a purchase from merchant 24. To accept payment with the payment card, merchant 24 must normally establish an account with a financial institution that is part of the financial payment system. This financial institution is usually called the “merchant bank,” the “acquiring bank,” or the “acquirer.” When cardholder 22 tenders payment for a purchase with a payment card, merchant 24 requests authorization from an acquirer or merchant bank 26 for the amount of the purchase. The request may be performed over the telephone, but is usually performed through the use of a point-of-sale terminal, which reads cardholder's 22 account information from a magnetic stripe, a chip, or embossed characters on the payment card and communicates electronically with the transaction processing computers of merchant bank 26. Alternatively, merchant bank 26 may authorize a third party to perform transaction processing on its behalf. In this case, the point-of-sale terminal will be configured to communicate with the third party. Such a third party is usually called a “merchant processor,” an “acquiring processor,” or a “third party processor.”

Using payment card interchange network 28, computers of merchant bank 26 or merchant processor will communicate with computers of issuer bank 30 by sending a payment card transaction authorization request. Based on the payment card transaction authorization request, issuer 30 determines whether cardholder's 22 account 32 is in good standing and whether the purchase is covered by cardholder's 22 available credit line. Based on these determinations, the request for authorization will be declined or accepted by issuer 30. If the request is accepted, an authorization code is issued to merchant 24.

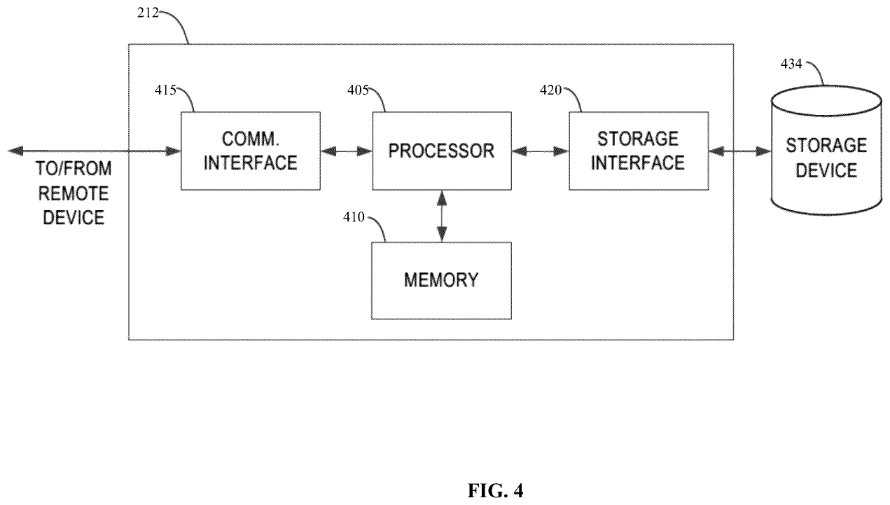

When a request for authorization is accepted, the available credit line of cardholder's 22 account 32 is decreased. Normally, a charge for a payment card transaction is not posted immediately to cardholder's 22 account 32 because bankcard associations, such as Mastercard International Incorporated®, have promulgated rules that do not allow merchant 24 to charge, or “capture,” a transaction until goods are shipped or services are delivered. However, with respect to at least some debit card transactions, a charge may be posted at the time of the transaction. When merchant 24 ships or delivers the goods or services, merchant 24 captures the transaction by, for example, appropriate data entry procedures on the point-of-sale terminal. This may include bundling of approved transactions daily for standard retail purchases. If cardholder 22 cancels a transaction before it is captured, a “void” is generated. If cardholder 22 returns goods after the transaction has been captured, a “credit” is generated. Payment card interchange network 28 and/or issuer bank 30 stores the payment card information, such as a type of merchant, amount of purchase, date of purchase, in a database 434 (shown in FIG. 4).

After a purchase has been made, a clearing process occurs to transfer additional transaction data related to the purchase among the parties to the transaction, such as merchant bank 26, payment card interchange network 28, and issuer bank 30. More specifically, during and/or after the clearing process, additional data, such as a time of purchase, a merchant name, a type of merchant, purchase information, cardholder account information, a type of transaction, itinerary information, information regarding the purchased item and/or service, and/or other suitable information, is associated with a transaction and transmitted between parties to the transaction as transaction data, and may be stored by any of the parties to the transaction.

After a transaction is authorized and cleared, the transaction is settled among merchant 24, merchant bank 26, and issuer bank 30. Settlement refers to the transfer of financial data or funds among merchant's 24 account, merchant bank 26, and issuer bank 30 related to the transaction. Usually, transactions are captured and accumulated into a “batch,” which is settled as a group. More specifically, a transaction is typically settled between issuer bank 30 and payment card interchange network 28, and then between payment card interchange network 28 and merchant bank 26, and then between merchant bank 26 and merchant 24.

In the example embodiment, payment card interchange network 28 routes payment card transaction authorization requests through post-authorization fraud analysis computing system 100. Accordingly, fraud analysis computing system 100 may be implemented as part of, or in association with, payment card interchange network 28. Fraud analysis computing system 100 may be the PAM system described herein that is configured to provide enhanced fraud detection to a payment processing system by using machine-learning tools to re-score (e.g., decision intelligence score or fraud indicator score) a transaction after the transaction has been initially scored and authorized to refine the score as a better indicator of whether the transaction is fraudulent. Detection of likely fraudulent activity may enable payment card interchange network 28 to inform merchant 24 and prevent fraudulent transactions prior to fulfilment of the purchased products or services (items) by merchant 24. Fraud analysis computing system 100 may be configured to provide fraud data (e.g., a fraud score generated based upon backward velocities and forward velocities) associated with payment card transaction to merchant 24, issued 30, and/or a downstream fraud management system (not shown) for further processing. Fraud analysis computing system 100 may be incorporated on one or more computing devices within payment card interchange network 28 or may be embodied in one or more separate components communicatively accessible to payment card interchange network 28.

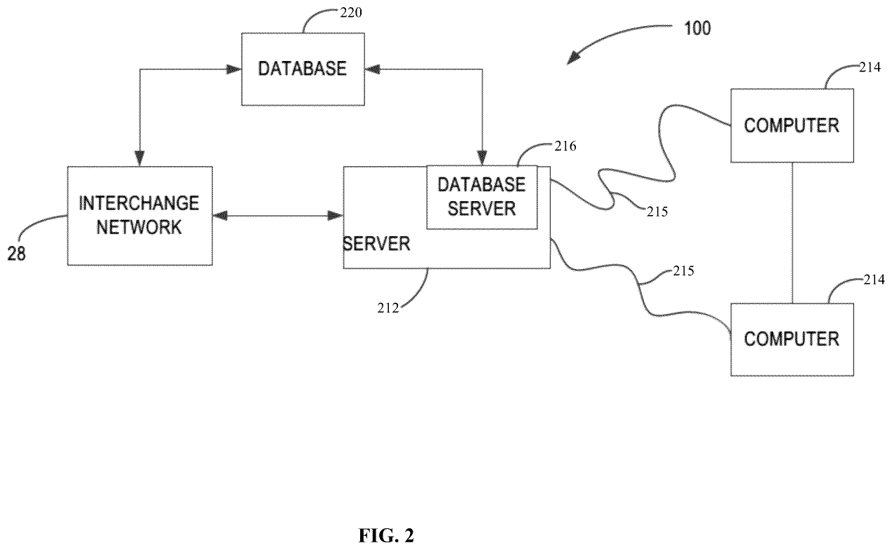

FIG. 2 is a simplified block diagram of an example fraud analysis computing system 100 in communication with payment interchange network 28 in accordance with one embodiment of the present disclosure. In the example embodiment, fraud analysis computing system 100 is implemented on a server system 212. A plurality of client systems 214 is connected to server system 212. In one embodiment, client systems 214 are computers including a web browser, such that server system 212 is accessible to client systems 214 using the Internet. Client systems 214 are interconnected to the Internet through network connections 215, such as a local area network (LAN) or a wide area network (WAN), dial-in-connections, cable modems, special high-speed Integrated Services Digital Network (ISDN) lines, and RDT networks. Client systems 214 could be any device capable of connecting to the Internet including a web-based phone, PDA, or other web-based connectable equipment.

Server system 212 includes a database server 216 connected to a database 220, which contains information on a variety of matters, as described below in greater detail. In one embodiment, database 220 is centralized on, for example, server system 212 and can be accessed by potential users at one of client systems 214 by logging onto server system 212 through one of client systems 214. In an alternative embodiment, database 220 is stored remotely from server system 212 and may be non-centralized.

Database 220 may include a single database having separated sections or partitions, or may include multiple databases, each being separate from each other. Database 220 may store transaction data generated over payment card interchange network 28 including data relating to payment card transactions, fraudulent payment card transactions, and fraud scoring values and rules. Database 220 may also store account data for a plurality of cardholders, including at least one of a cardholder name, a cardholder address, an account number, other account identifiers, and transaction information. Database 220 may also store merchant data including a merchant identifier that identifies each merchant registered to use the network, and instructions for settling transactions including merchant bank account information. Database 220 may also store purchase data associated with items being purchased by a cardholder from a merchant, and authorization request data. Database 220 may also store fraud information received from fraud analysis computing system 100.

In the example embodiment, one of client systems 214 is a user computer device associated with a user of fraud analysis computing system 100. For example, the user computer device is configured to display graphical user interface generated by fraud analysis computing system 100 via a web browser or dashboard application (e.g., a frontend application, a desktop application, or a web browser application) installed on the user computer device. Web browsers enable users of client system 214 to display and interact with media and other information typically embedded on a web page or a website associated with server system 212. Dashboard application allows users to interact with a server application on server system 212.

Others of client systems 214 may be associated with acquirer or merchant bank 26 and issuer 30 (shown in FIG. 1). In addition, client systems 214 may include a computer system associated with at least one of an online bank, a bill payment outsourcer, an acquirer bank, an acquirer processor, an issuer bank associated with a payment card, an issuer processor, a remote payment system, customers and/or billers. In the example embodiment, server system 212 is associated with payment card interchange network 28 and may be referred to as an interchange computer system. Server system 212 may be used for general processing of payment card transaction data as well as analyzing fraud data associated with payment card transactions.

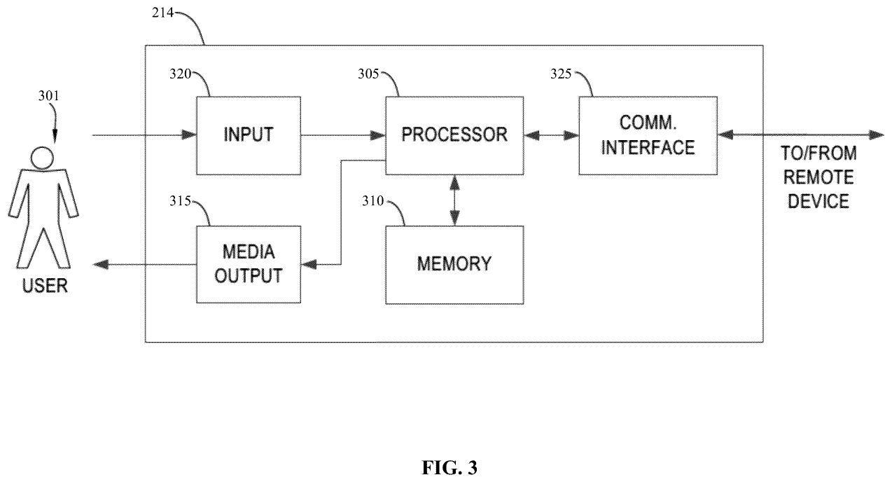

FIG. 3 illustrates an example configuration of one of client systems 214 operated by a user 301, such as an analyst. In the example embodiment, client system 214 includes a processor 305 for executing instructions. In some embodiments, executable instructions are stored in a memory area 310. Processor 305 may include one or more processing units, for example, a multi-core configuration. Memory area 310 is any device allowing information such as executable instructions and/or written works to be stored and retrieved. Memory area 310 may include one or more computer readable media.

Client system 214 also includes at least one media output component 315 for presenting information to user 301. Media output component 315 is any component capable of conveying information to user 301. For example, media output component is configured to display graphical user interface to user 301. In some embodiments, media output component 315 includes an output adapter such as a video adapter and/or an audio adapter. An output adapter is operatively coupled to processor 305 and operatively coupleable to an output device such as a display device, a liquid crystal display (LCD), organic light emitting diode (OLED) display, or “electronic ink” display, or an audio output device, a speaker or headphones.

In some embodiments, client system 214 includes an input device 320 for receiving input from user 301. Input device 320 may include, for example, a keyboard, a pointing device, a mouse, a stylus, a touch sensitive panel, a touch pad, a touch screen, a gyroscope, an accelerometer, a position detector, or an audio input device. A single component such as a touch screen may function as both an output device of media output component 315 and input device 320. Client system 214 may also include a communication interface 325, which is communicatively coupleable to a remote device such as server system 212. Communication interface 325 may include, for example, a wired or wireless network adapter or a wireless data transceiver for use with a mobile phone network, Global System for Mobile communications (GSM), 3G, or other mobile data network or Worldwide Interoperability for Microwave Access (WIMAX).

FIG. 4 illustrates an example configuration of server system 212. Server system 212 includes a processor 405 for executing instructions. Instructions may be stored in a memory area 410, for example. Processor 405 may include one or more processing units (e.g., in a multi-core configuration) for executing instructions. The instructions may be executed within a variety of different operating systems on the server system 212, such as UNIX, LINUX, Microsoft Windows®, etc. It should also be appreciated that upon initiation of a computer-based method, various instructions may be executed during initialization. Some operations may be required in order to perform one or more processes described herein, while other operations may be more general and/or specific to a particular programming language (e.g., C, C #, C++, Java, or other suitable programming languages, etc.).

Processor 405 is operatively coupled to a communication interface 415 such that server system 212 is capable of communicating with remote devices such as client systems 214 (shown in FIG. 2) or another server system 212. For example, communication interface 415 may receive requests from client system 214 via the Internet, as illustrated in FIG. 2.

Processor 405 may also be operatively coupled to a storage device 434, which may be used to implement database 220. Storage device 434 is any computer-operated hardware suitable for storing and/or retrieving data. In some embodiments, storage device 434 is integrated in server system 212. For example, server system 212 may include one or more hard disk drives as storage device 434. In other embodiments, storage device 434 is external to server system 212 and may be accessed by a plurality of server systems 212. For example, storage device 434 may include multiple storage units such as hard disks or solid state disks in a redundant array of inexpensive disks (RAID) configuration. Storage device 434 may include a storage area network (SAN) and/or a network attached storage (NAS) system.

In some embodiments, processor 405 is operatively coupled to storage device 434 via a storage interface 420. Storage interface 420 is any component capable of providing processor 405 with access to storage device 434. Storage interface 420 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing processor 405 with access to storage device 434.

Memory area 410 may include, but is not limited to, random access memory (RAM) such as dynamic RAM (DRAM) or static RAM (SRAM), read-only memory (ROM), erasable programmable read-only memory (EPROM), electrically erasable programmable read-only memory (EEPROM), and non-volatile RAM (NVRAM). The above memory types are exemplary only and are thus not limiting as to the types of memory usable for storage of a computer program.

In operation, fraud analysis computing system 100 runs on server system 212. User 301 (shown in FIG. 3) interacts with server system 212 using one of client systems 214 (shown in FIG. 2).

FIG. 5A shows an example data engineering pipeline 500a of the fraud analysis computing system (or the PAM system) 100 shown in FIG. 1. The data engineering pipeline 500a of the PAM system 100 may include components like a pipeline generator 502, a velocity creator 504, a pipeline integrator 506, and/or datastores 508. The pipeline generator 502 may be implemented as an interactive job which may perform various steps or operations repeatedly (periodically or aperiodically) to advance through a modeling data window and generate velocities (e.g., regular historical velocities and/or forward velocities) for a training window. The training window may include the lookback period for the regular historical velocities and the look forward period for the forward velocities.

The velocity creator 504 may be a subcomponent of the pipeline generator 502, and the velocity creator 504 may generate the regular historical velocities and the forward velocities based upon data associated with transactions in the lookback period and the look forward period. The velocity creator 504 may generate the regular historical velocities and the forward velocities in accordance with candidate velocity configurations 514. The candidate velocity configurations 514 provide description of all features and how to compute various features. The pipeline integrator 506 may be implemented as a process or a task that merges the regular historical velocities, forward velocities, and various transaction elements for transactions in the lookback period and the look forward period.

The datastores 508 may include a transaction table datastore 510 and full mod training data datastore 512. The transaction table datastore 510 may include transactions and their related elements to create the regular historical velocities and forward velocities. The velocity creator 504 may fetch data from the transaction table datastore 510 to create or generate the regular historical velocities and forward velocities. In some embodiments, data fetched from the transaction table datastore 510 may be prepared (e.g., filtered) by a data preparation module 505. The full mod training data datastore 512 may include an n-month transaction dataset consisting of raw data fields and the derived regular historical velocities and forward velocities outputted by the pipeline integrator 506. Accordingly, the n-month transaction dataset may include transactions for n number of months of which transactions are used for training and validation.

In other words, the pipeline generator 502 is configured to perform a set of processes that runs over a dataset fetched from an existing transaction table 508 and creates an intermediate dataset referred as a “scoring window,” which enables the velocity creator 504 to generate forward and backward velocities on the set of selected transactions. The dataset fetched from the existing transaction table 510 may be prepared for creating the intermediate dataset by extracting or fetching transaction level data elements from the transactional data. By way of a non-limiting example, the transaction level data elements may include, but are not limited to, a merchant identification number, a card number, a declined transaction indicator, a fraudulent transaction indicator, a decision intelligence (DI) score, and/or fraud labels. The transaction data elements may be extracted from transactions that occurred over the lookback period (e.g., the last 56 days, or any other number of days) prior to creating or generating the training snapshot for generating the regular historical velocities, and up to the look forward period (e.g., 15 minutes after the last transaction of the snapshot) for creating or generating the forward velocities. Additionally, declined transactions having a positive decline labeling logic (DLL) label may also be used for training the model.

In some embodiments, different anchors including an identifier key, a transaction type, an amount or count velocity, a response code, a forward peek time period, and/or derived velocities may be considered for generating forward velocities. The identifier key may include a card number (card_num), a merchant identifier (merch), and/or a merchant category code (MCC). The transaction type may include aiss, aoth, auth, cp, cnp, debit, decline, money_send_mcc, xbr, xbr_cnp, txn, cvv_ver, and/or cvv_unver. The amount or count velocity may include a sum of transaction (sum) authorized amount and/or a number of transactions (count). The response code may include a response code of the card's last transaction and/or the response code of the current transaction. The forward peek time period may be 1 minute (fwd1m), 5 minutes (fwd5m), 10 minutes (fwd10m), and/or 15 minutes (fwd15m). The derived velocities may be represented as a ratio (rat), a difference (ps), and/or a distribution (dist). Accordingly, forward velocities may be generated based upon one or more combinations of anchors, for example, card_num_cnp_count_fwd10m_fwd15m_rat, card_num_xbr_cnp_sum_fwd1m_fwd5m_ps, and/or card_num_decl_count_cur_fwd1m_dist.

Similarly, as described herein, the velocity creator 504 generates the forward velocities and the backward velocities for each transaction in the scoring window including the lookback period and the look forward period. In some embodiments, the velocity creator 504 may import or fetch backward velocities stored in a data management platform as a near real-time feed instead of generating the backward velocities.

FIG. 5B shows an example data modeling pipeline 500b of the fraud analysis computing system (or the PAM system) 100 shown in FIG. 1. The data modeling pipeline 500b of the PAM system 100 may include a process or task that is referenced herein as modeling iterations 516 leveraging data science workbench tools and the conventional cross-industry standard process for data mining (CRISP-DM) using the n-month transaction dataset stored in the full mod training data datastore 512. The modeling iterations process may generate a feature set providing a configuration-based description of all features and how to compute the features. Additionally, the modeling iterations process 516 may also generate model configuration files 520 for deploying in a transactions processing platform (TPP). The data modeling pipeline 500b may use the datasets generated by the pipeline integrator 506 for model training, validation, and/or testing by (i) identifying optimal model hyper-params (e.g., a number of trees, a learning rate, or depth, etc.); (ii) finalizing a minimal set of features base; and (iii) validating the model performance over a blind dataset to capture model performance metrics. The modeling iterations thus delivers a final feature set 518 and model configuration files 520 for use by a scoring manager (shown in FIG. 5C) of a deployment pipeline that is described below with regards to FIG. 5C. By way of a non-limiting example, the model configurations files 520 may include, but are not limited to, a model governance document 522, a model overview document 524, and/or a model CRISM-DM document 526.

FIG. 5C shows an example data deployment pipeline 500c of the fraud analysis computing system (or the PAM system) 100 shown in FIG. 1. The deployment pipeline 500c of the PAM system 100 may include functional blocks performing computations in real-time and near real time settings for deploying tree-based trained classifier. The deployment pipeline 500c may include a scoring manager 528 including a transaction feature snapshot buffer 530, a TPP scoring component 532, and a TPP velocity engine 534. The TPP scoring component 532 takes the feature set 518 and model configuration files 520 generated by the data modeling pipeline 500b as inputs to the transactions scoring model. The TPP scoring component 532 may also trigger the TPP velocity engine 534 that generates a transaction feature snapshot that corresponds with the regular historical velocities and forward velocities for a particular transaction. In some embodiments, and by way of a non-limiting example, the TPP velocity engine 534 may port traditional transaction features or the regular historical velocities from a data management platform 536 as real time authorization transaction data feed 538. The real time authorization transaction data feed 538 may include a filtered set of the regular historical velocities required for the model with a small delay from the actual time of transaction. The transaction feature snapshot buffer 530 may store the regular historical velocities for the particular transaction for later scoring (re-scoring) with the forward velocities for the maximum period of 30 minutes, for example. Additionally, or alternatively, the TPP velocity engine 534 may also use one or more transaction feeds 540 including data elements for computing velocity in near-real time (e.g., with a delay of a couple of seconds from the actual time of transaction). The TPP scoring component 532 may provide the score value 542 generated based upon the regular historical velocities and forward velocities to a merchant, an acquirer, or a user computing device for displaying in a graphical user interface. By way of a non-limiting example, the score value 542 may be provided using a push application programming interface or a pull application programming interface.

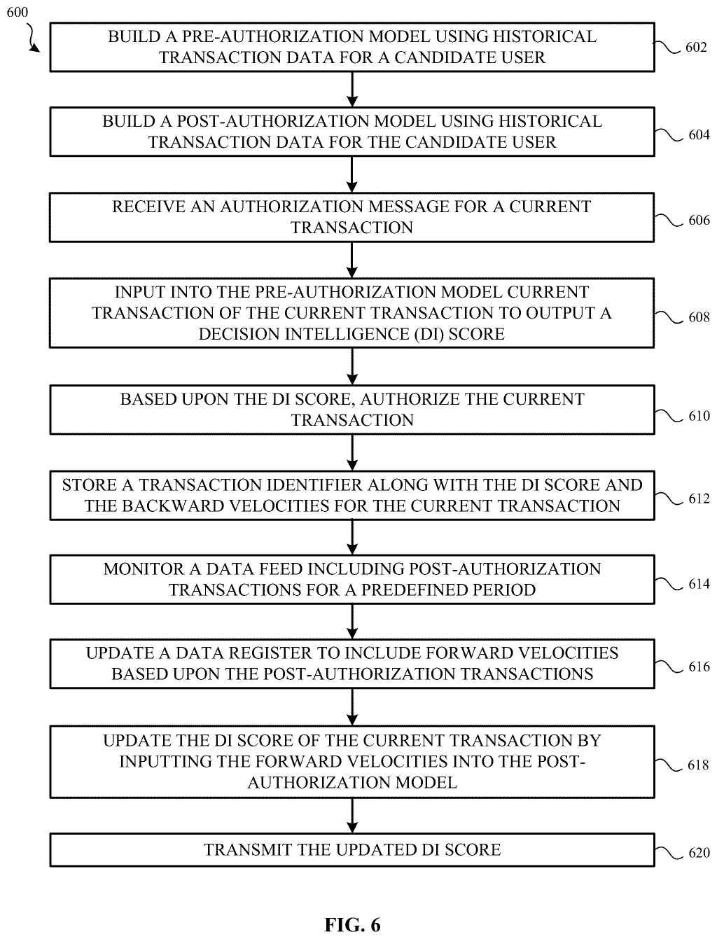

FIG. 6 is a flow diagram 600 of a computer-implemented method for applying post-authorization modeling tools to a payment transaction for enhancing a decision intelligence (DI) score. The method described using the flow diagram 600 uses at least one computing device, such as fraud analysis computing system 100 to perform method operations. The at least one computing device has at least one processor, such as processor 405, and the at least one processor performs the method operations.

The method operations include building 602 a pre-authorization model using historical transaction data for a candidate user. The pre-authorization model may be built or generated by the TPP velocity engine 534. The generated pre-authorization model is configured to analyze backward velocities. The method operations further include building 604 a post-authorization model using historical transaction data for the candidate user. The post-authorization model is configured to analyze forward velocities. The pre-authorization model and/or the post-authorization model are generated using the data engineering pipeline 500a and the data modeling pipeline 500b.

The method operations further include receiving 606 an authorization message for a current transaction including current transaction data including at least an account identifier and a merchant identifier. The account identifier identifies an account used to initiate the current transaction, and the merchant identifier identifies a merchant with whom the current transaction was initiated with. Further, the method operations include inputting 608 the current transaction data and the backward velocities for the current transaction into the pre-authorization model to output a DI score. As described herein, the current transaction includes a transaction identifier. The method operations further include authorizing 610 the current transaction based upon the DI score, which is generated based upon the backward velocities only. The DI score and the backward velocities are then stored 612 in a data register along with the transaction identifier of the current transaction.

The method operations further include continuously monitoring 614 a data feed for a predefined period of time after authorizing the current transaction to detect any post-authorization transactions initiated using the same account identifier. The predefined period may be up to 15 minutes. The method operations further including updating 616 data register for the transaction identifier to include the forward velocities for any post-authorization transactions received during the predefined period of time in the monitored data feed. In response to the predefined period of time expiring, the DI score for the current transaction is updated 618 by inputting the forward velocities into the post-authorization model. The updated DI score is then transmitted 620 to the merchant with whom the current transaction was initiated. The updated DI score above a specific threshold value may indicate that the current transaction is a fraudulent transaction. The specific threshold value may be 900, for example. The updated DI score may be transmitted after the predefined period corresponding to the forward velocities is expired. In other words, the updated DI score may be transmitted to the merchant soon after the DI score is updated and/or before the merchant fulfils an order associated with the current transaction, which is identified as a fraudulent transaction.

As used herein, “machine learning” refers to statistical techniques to give computer systems the ability to “learn” (e.g., progressively improve performance on a specific task) with data, without being explicitly programmed for that specific task.

As will be appreciated based on the foregoing specification, the above-discussed embodiments of the disclosure may be implemented using computer programming or engineering techniques including computer software, firmware, hardware or any combination or subset thereof. Any such resulting program, having computer-readable and/or computer-executable instructions, may be embodied or provided within one or more computer-readable media, thereby making a computer program product, i.e., an article of manufacture, according to the discussed embodiments of the disclosure. The computer readable media may be, for instance, a fixed (hard) drive, diskette, optical disk, magnetic tape, semiconductor memory such as read-only memory (ROM) or flash memory, etc., or any transmitting/receiving medium such as the Internet or other communication network or link. The article of manufacture containing the computer code may be made and/or used by executing the instructions directly from one medium, by copying the code from one medium to another medium, or by transmitting the code over a network.

As used herein, the term “non-transitory computer-readable media” is intended to be representative of any tangible computer-based device implemented in any method or technology for short-term and long-term storage of information, such as, computer-readable instructions, data structures, program modules and sub-modules, or other data in any device. Therefore, the methods described herein may be encoded as executable instructions embodied in a tangible, non-transitory, computer readable medium, including, without limitation, a storage device and/or a memory device. Such instructions, when executed by a processor, cause the processor to perform at least a portion of the methods described herein. Moreover, as used herein, the term “non-transitory computer-readable media” includes all tangible, computer-readable media, including, without limitation, non-transitory computer storage devices, including, without limitation, volatile and nonvolatile media, and removable and non-removable media such as a firmware, physical and virtual storage, CD-ROMs, DVDs, and any other digital source such as a network or the Internet, as well as yet to be developed digital means, with the sole exception being a transitory, propagating signal.

As used herein, the term “computer” and related terms, e.g., “computing device”, are not limited to integrated circuits referred to in the art as a computer, but broadly refers to a microcontroller, a microcomputer, a programmable logic controller (PLC), an application specific integrated circuit, and other programmable circuits, and these terms are used interchangeably herein.

As used herein, the term “cloud computing” and related terms, e.g., “cloud computing devices” refers to a computer architecture allowing for the use of multiple heterogeneous computing devices for data storage, retrieval, and processing. The heterogeneous computing devices may use a common network or a plurality of networks so that some computing devices are in networked communication with one another over a common network but not all computing devices. In other words, a plurality of networks may be used in order to facilitate the communication between and coordination of all computing devices.

As used herein, the term “mobile computing device” refers to any computing device which is used in a portable manner including, without limitation, smart phones, personal digital assistants (“PDAs”), computer tablets, hybrid phone/computer tablets (“phablet”), or other similar mobile device capable of functioning in the systems described herein. In some examples, mobile computing devices may include a variety of peripherals and accessories including, without limitation, microphones, speakers, keyboards, touchscreens, gyroscopes, accelerometers, and metrological devices. Also, as used herein, “portable computing device” and “mobile computing device” may be used interchangeably.

Approximating language, as used herein throughout the specification and claims, may be applied to modify any quantitative representation that could permissibly vary without resulting in a change in the basic function to which it is related. Accordingly, a value modified by a term or terms, such as “about” and “substantially”, are not to be limited to the precise value specified. In at least some instances, the approximating language may correspond to the precision of an instrument for measuring the value. Here and throughout the specification and claims, range limitations may be combined and/or interchanged, such ranges are identified and include all the sub-ranges contained therein unless context or language indicates otherwise.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

1. A computing system for applying post-authorization modeling tools to a payment transaction for enhancing a decision intelligence (DI) score, the computing system comprising at least one processor, and at least one memory in communication with the at least one processor, the at least one processor programmed to:
build, using a velocity engine, a pre-authorization model using historical transaction data, the pre-authorization model configured to analyze backward velocities;
build, using the velocity engine, a post-authorization model using historical transaction data, the post-authorization model configured to analyze forward velocities;
receive an authorization message for a current transaction including current transaction data including at least an account identifier identifying an account used to initiate the current transaction, and a merchant identifier identifying a merchant with whom the current transaction was initiated with;
input into the pre-authorization model the current transaction data and the backward velocities for the current transaction to output a DI score, wherein the current transaction includes a transaction identifier;
based upon the DI score, authorize the current transaction;
store, in a data register within the at least one memory, the transaction identifier along with the DI score and the backward velocities for the current transaction;
continuously monitor a data feed for a predefined period of time after authorizing the current transaction to detect any post-authorization transactions initiated using the same account identifier;
update the data register within the at least one memory for the transaction identifier to include the forward velocities for any post-authorization transactions received during the predefined period of time;
in response to the predefined period of time expiring, update the DI score for the current transaction by inputting the forward velocities into the post-authorization model; and
transmit the updated DI score to the merchant with whom the current transaction was initiated with.

2. The computing system of claim 1, wherein the updated DI score is transmitted to the merchant before the merchant fulfils an order associated with the current transaction.

3. The computing system of claim 1, wherein the backward velocities are determined or calculated based upon transactions for the account identifier for a specific period prior to the current transaction.

4. The computing system of claim 3, wherein the specific period prior to the current transaction is 30 to 60 days prior to the current transaction.

5. The computing system of claim 1, wherein the forward velocities are based upon transactions initiated for the account identifier for up to the predefined period after the current transaction.

6. The computing system of claim 5, wherein the predefined period after the current transaction is 15 minutes.

7. The computing system of claim 1, wherein the historical transaction data extracted for analyzing the backwards velocities include a merchant identifier, a card number, a transaction decline indicator, a transaction fraud indicator, or fraud labels.

8. The computing system of claim 1, wherein the forward velocities are analyzed using data anchors including a card number, a merchant identifier, and/or and a merchant category code.

9. The computing system of claim 8, wherein the forward velocities are analyzed further based upon data parameters including a transaction type, a transaction amount, a number of transactions or count velocity, a response code, a forward peek time period, and derived velocities.

10. A computer-implemented method for applying post-authorization modeling tools to a payment transaction for enhancing a decision intelligence (DI) score, the method implemented by a computing system including at least one processor, the method comprising:
building a pre-authorization model using historical transaction data, the pre-authorization model configured to analyze backward velocities;
building a post-authorization model using historical transaction data, the post-authorization model configured to analyze forward velocities;
receiving an authorization message for a current transaction including current transaction data including at least an account identifier identifying an account used to initiate the current transaction, and a merchant identifier identifying a merchant with whom the current transaction was initiated with;
inputting into the pre-authorization model the current transaction data and the backward velocities for the current transaction to output a DI score, wherein the current transaction includes a transaction identifier;
based upon the DI score, authorizing the current transaction;
storing, in a data register within at least one memory, the transaction identifier along with the DI score and the backward velocities for the current transaction;
continuously monitoring a data feed for a predefined period of time after authorizing the current transaction to detect any post-authorization transactions initiated using the same account identifier;
updating the data register within the at least one memory for the transaction identifier to include the forward velocities for any post-authorization transactions received during the predefined period of time;
in response to the predefined period of time expiring, updating the DI score for the current transaction by inputting the forward velocities into the post-authorization model; and
transmitting the updated DI score to the merchant with whom the current transaction was initiated with.

11. The computer-implemented method of claim 10, the updated DI score is transmitted to the merchant before the merchant fulfils an order associated with the current transaction.

12. The computer-implemented method of claim 10, further comprising determining or calculating the backward velocities based upon transactions for the account identifier for a specific period prior to the current transaction.

13. The computer-implemented method of claim 12, wherein the specific period prior to the current transaction is between 30 and 60 days prior to the current transaction.

14. The computer-implemented method of claim 10, wherein the forward velocities are based upon transactions initiated for the account identifier for up to the predefined period after the current transaction.

15. The computer-implemented method of claim 14, wherein the predefined period after the current transaction is 15 minutes.

16. The computer-implemented method of claim 10, wherein the historical transaction data extracted for analyzing the backwards velocities include a merchant identifier, a card number, a transaction decline indicator, a transaction fraud indicator, or fraud labels.

17. The computer-implemented method of claim 10, wherein the forward velocities are analyzed using data anchors including a card number, a merchant identifier, and/or and a merchant category code.

18. The computer-implemented method of claim 17, wherein the forward velocities are analyzed further based upon data parameters including a transaction type, a transaction amount, a number of transactions or count velocity, a response code, a forward peek time period, and derived velocities.

19. At least one non-transitory computer-readable storage media having computer-executable instructions embodied thereon for applying post-authorization modeling tools to a payment transaction for enhancing a decision intelligence (DI) score, wherein the computer-executable instructions when executed by at least one processor, cause the at least one processor to:
build, using a velocity engine, a pre-authorization model using historical transaction data, the pre-authorization model configured to analyze backward velocities;
build, using the velocity engine, a post-authorization model using historical transaction data, the post-authorization model configured to analyze forward velocities;
receive an authorization message for a current transaction including current transaction data including at least an account identifier identifying an account used to initiate the current transaction, and a merchant identifier identifying a merchant with whom the current transaction was initiated with;
input into the pre-authorization model the current transaction data and the backward velocities for the current transaction to output a DI score, wherein the current transaction includes a transaction identifier;
based upon the DI score, authorize the current transaction;
store, in a data register within at least one memory, the transaction identifier along with the DI score and the backward velocities for the current transaction;
continuously monitor a data feed for a predefined period of time after authorizing the current transaction to detect any post-authorization transactions initiated using the same account identifier;
update the data register within the at least one memory for the transaction identifier to include the forward velocities for any post-authorization transactions received during the predefined period of time;
in response to the predefined period of time expiring, update the DI score for the current transaction by inputting the forward velocities into the post-authorization model; and
transmit the updated DI score to the merchant with whom the current transaction was initiated with.

20. The at least one non-transitory computer-readable storage media of claim 19, wherein the computer-executable instructions further cause the at least one processor to transmit the updated DI score to the merchant before the merchant fulfils an order associated with the current transaction.
